(19) United States
(12) Patent Application Publication
(10) Pub. No.: US 2014/0107237 A1
(43) Pub. Date: Apr. 17, 2014

(54) CATION-STRUNG SIDE CHAIN POLYMERS USEFUL IN HYDROXIDE/ANION EXCHANGE MEMBRANES

(71) Applicant: University of Delaware, Newark, DE (US)

(72) Inventors: Yushan YAN, Hockessin, DE (US); Junhua Wang, Newark, DE (US); Shuang Gu, Newark, DE (US)

(21) Appl. No.: 14/048,500

(22) Filed: Oct. 8, 2013

Related U.S. Application Data
(60) Provisional application No. 61/711,293, filed on Oct. 9, 2012.

(51) Int. Cl. H01M 8/02

(52) U.S. Cl. CPC H01M 8/0291
USPC 521/27; 521/30

(57) ABSTRACT

This invention provides a family of cation-strung polymers capable of forming membranes having exceptional hydroxide ionic conductivity as well as low water uptake and methods of making the same. The invention also provides for using these cation-strung polymers to manufacture membranes useful in HEMFC fuel cells and other devices such as electrolysis, solar hydrogen generation, redox flow battery, dialysis, reverse osmosis, forward osmosis, pervaporation, ion exchange, sensor, and gas separation.

### CROSS-REFERENCE TO RELATED APPLICATION

This application claims the benefit of U.S. Provisional Application No. 61/711,293, filed Oct. 9, 2012, the disclosure of which is incorporated herein by reference in its entirety for all purposes.

### GOVERNMENT FUNDING

This invention was made with government support under W911NF-10-1-0520 awarded by MURI program of the ARO. The government has certain rights in the invention.

### FIELD OF THE INVENTION

The present invention relates to the field of fuel cells and specifically to hydroxide exchange membrane fuel cells (HEMFCs). It provides polymers, and methods of making such polymers, that are capable of forming membranes having exceptional hydroxide conductivity, low water uptake, and excellent temperature resistance. The invention also provides membranes including the polymers for use in anion exchange membrane fuel cells (AEMFCs) and other anion exchange membrane based devices for applications in electrolysis, solar hydrogen generation, redox flow battery, dialysis, reverse osmosis, forward osmosis, pervaporation, ion exchange, sensor, and gas separation.

### BACKGROUND OF THE INVENTION

Polymer proton exchange membrane fuel cells (PEMFCs) are considered clean and efficient power sources. However, the high cost and unsatisfactory durability of catalysts are major barriers for their large scale commercialization. By switching the polymer electrolyte from the “acidic” condition to a “basic” one, hydroxide exchange membrane fuel cells (HEMFCs) have shown the potential to become truly affordable and viable power sources because of their ability to work with non-precious metal catalysts and inexpensive hydrocarbon membranes. Key to HEMFCs, hydroxide exchange membranes (HEMs) control cell performance and durability through their ionic conductivity and morphological stability. Specifically, high hydroxide conductivity and low water uptake are required simultaneously for high-performance HEMs.

In comparison to proton exchange membranes, hydroxide exchange membranes would have intrinsically lower ion conductivity under similar conditions, because the mobility of OH⁻ is lower than that of H⁺. High ion exchange capacity (IEC) is needed for HEMs to achieve high conductivity. However, high IEC usually leads to excessive water uptake, decreasing the morphological stability and mechanical strength.

The undesirable correlation between the two parameters, hydroxide conductivity and water uptake, presents challenges to the preparation of hydroxide exchange membranes. In particular, achieving a high hydroxide conductivity while maintaining a low water uptake will be difficult.

The prior art discloses various approaches including chemical cross-linking, physical reinforcement, and block-copolymer architecture to manipulate the correlation to lower water uptake while maintaining high hydroxide conductivity. These techniques, however, can bring challenges including reduced flexibility, lowered stability and/or decreased compatibility. Therefore, the general trade-off between high hydroxide conductivity and low water uptake has been a great bottleneck in designing high-performance HEMs.

### SUMMARY OF THE INVENTION

This invention provides a novel way to efficiently overcome the above-mentioned tradeoff by tuning the relation between hydroxide conductivity and water uptake. This approach involves stringing cations on side chains attached to backbone polymers to create highly concentrated yet ordered hydrophilic domains, wherein the side chains do not interfere with the ability of the polymer backbone to form hydrophobic domains (as illustrated in schematic form in FIG. 1). The invention thus provides a cation-strung polymer comprised of a polymer backbone of a parent polymer and one or more side chains attached to the polymer backbone, wherein the side chains each contain a plurality of cationic sites (groups). The cationic sites are strung out along the side chains and may be located in the backbone of the side chain or may be pendant thereto. The polymer backbone of the parent polymer, in one embodiment of the invention, is non-ionic. Upon membrane formation, the cation-strung side chains as well as the absorbed water will form a hydrophilic phase and at the same time, the polymer main-chain (backbone) will form a hydrophobic phase, establishing an ideal bi-continuous membrane micro-structure. The hydrophilic phase offers high ion (e.g., hydroxide) conductivity, while the hydrophobic phase provides mechanical stability and suppresses the water uptake. The provided polymers contain cations strung out along side chains attached to a polymer backbone, and therefore are referred to herein as “cation-strung” polymers.

Thus, one aspect of the present invention provides a cation-strung polymer comprised of a polymer backbone of a parent polymer and one or more side chains attached to the polymer backbone, wherein the side chains each contain a plurality of cationic sites. The cationic sites may, for example, be selected from the group consisting of ammonium, phosphonium, guanidinium, imidazolium, sulfonium, pyridinium, cobalticinium and other metal-based cationic sites containing metals such as ruthenium. The parent polymer may be selected from the group consisting of polysulfones, polystyrenes, poly(ether sulfones), poly(ether sulfones)-cardo, poly(ether ketones), poly(ether ketones)-cardo, poly(ether ether ketones), poly(ether ether ketone ketones), poly(phthazinone ether sulfone ketones), polyetherimides, poly(phenylenes), poly(aryl ethers), poly(phenylene oxides) vinyl aliphatic/aromatic polymers and fluorinated polymers. They may be random, block or graft polymers. In one embodiment of the invention, the side chains are aromatic or aliphatic or a combination thereof. The side chains may, for example, comprise repeating units having the structure [CH₂—N⁺(CH₃)₂—CH₂—R—], wherein R is phenyl or biphenyl or —(CH₂)ₙ— and n=0 to 20. The side chains comprise quaternary phosphonium-substituted polystyrene chains in one embodiment of the invention.

Also provided by the present invention is a method of making a cation-strung polymer comprising attaching a cation-strung side chain precursor to a backbone of a parent polymer. The cation-strung side chain precursor may be an aromatic or aliphatic cation-strung side chain precursor or a combination thereof.

The parent polymer may be selected from the group consisting of polysulfones, polystyrenes, poly(ether sulfones), poly(ether sulfones)-cardo, poly(ether ketones), poly(ether ketones)-cardo, poly(ether ether ketones), poly(ether ether ketone ketones), poly(phthazinone ether sulfone ketones), polyetherimides, poly(phenylenes), poly(aryl ethers), poly(phenylene oxides), vinyl aliphatic/aromatic polymers and fluorinated polymers The cation-strung side chain precursor and the parent polymer may each bear functional groups reactive with each other (i.e., a functional group on the cation-strung side chain precursor is reactive with a functional group on the parent polymer, such that following reaction of the functional groups a bond between the side chain and the parent polymer is formed). For example, the parent polymer may be selected from the group consisting of tertiary amine-substituted polysulfones, chloromethylated polysulfones and brominated poly(phenylene oxides). The cation-strung side chain precursor may be comprised of repeating units having the structure [CH₂—N⁺(CH₃)₂—CH₂—R—], wherein R is phenyl or biphenyl or —(CH₂)ₙ—, with n=0 to 20. The cation-strung side chain precursor may, for example, bear a tertiary amine or chloromethyl or bromomethyl group capable of reacting with a functional group on the parent polymer. For example, the cation-strung side chain precursor may have the structure (H₃C)₂N—[—(CH₂)ₘN⁺(CH₃)₂—]ₙ—(CH₂)ₘ—N⁺(CH₃)₃(n+1)X⁻, wherein m is 1 to 20, n is 0 to 97, and X is a halogen. In another embodiment, the cation-strung side chain precursor may have the structure ClH₂C—BP—CH₂—[—N⁺(CH₃)₂—CH₂—BP—CH₂—]₀—N⁺(CH₃)₃(o+1)X⁻, wherein BP is biphenyl, o is 0 to 97 (e.g., 1 to 10) and X is a halogen.

Another method of making a cation-strung polymer provided by the present invention comprises grafting a chloromethylated vinyl aromatic monomer such as 4-chloromethylstyrene onto a parent polymer (such as a polysulfone containing at least one dithiobenzoate group) using reversible addition-fragmentation chain-transfer polymerization (RAFT) to obtain a graft copolymer bearing side chains of poly(chloromethylated vinyl aromatic monomer) and reacting the graft copolymer with a tertiary phosphine (such as tris(2,4,6-trimethoxyphenyl)phosphine) to introduce quaternary phosphonium groups into the side chains.

Also provided by the present invention is a method of making a cation-strung polymer comprising grafting a methylated vinyl aromatic monomer (such as 4-methylstyrene) onto a parent polymer (such as a polysulfone containing at least one chloromethyl group substituted on an aromatic ring) using atom transfer random polymerization (ATRP) to obtain a first graft copolymer bearing side chains of poly(methylated vinyl aromatic monomer), brominating the first graft copolymer to obtain a second graft copolymer bearing side chains containing bromomethyl groups, and reacting the second graft copolymer with a tertiary phosphine (such as tris(2,4,6-trimethoxyphenyl)phosphine) to introduce quaternary phosphonium groups into the side chains.

In another aspect of the invention, a hydroxide exchange membrane comprised of a cation-strung polymer in accordance with the above description is provided.

Also provided by the present invention is a hydroxide exchange fuel cell comprising a membrane of a cation-strung polymer in accordance with the above description.

In another aspect of the invention, anion exchange membranes (AEMs, with HEMs being one type of AEM) comprised of cation-strung polymers are provided. The anion, for example, may be halide, carbonate, bicarbonate, acetate, cyanide, nitrate, phosphate or oxide. AEMs with cation-strung architecture have a wide range of applications, such as electrolysis, solar hydrogen generation, redox flow battery, dialysis, reverse osmosis, forward osmosis, pervaporation, ion exchange, sensor, and gas separation.

### BRIEF DESCRIPTION OF THE FIGURES

FIG. 1 shows, in schematic form, the molecular structure of an illustrative cation-strung polymer useful for the manufacture of hydroxide/anion exchange membranes.

FIG. 2 shows a scheme for synthesizing a precursor useful for forming a side chain on a cation-strung polymer.

FIG. 3 shows a scheme for the preparation of a tertiary amine-functionalized polysulfone useful as a parent polymer in synthesizing a cation-strung polymer.

FIG. 4 shows a scheme for synthesizing a quaternary ammonium cation-strung polysulfone (SQAPSF-C10).

FIG. 5 shows the chemical structure of a poly(aryl ether sulfone) functionalized by quaternary ammonium (QAPS), which can be used to provide a HEM. This polymer does not have a cation-strung structure.

FIG. 6a illustrates the water uptake of SQAPSF-C10-25 and QAPS-75 at different temperatures in pure water. Under the similar conductivity, SQAPSF-C10-25 shows much lower water uptake than QAPS-75, in particular at elevated temperatures. For example, at 40° C., the water uptake of SQAPSF-C10-25 is 60%, in comparison to 250% for QAPS-75. At 80° C., the water uptake of SQAPSF-C10-25 was only 85%, while QAPS-75 could not be tested due to partially dissolution in water.

FIG. 6b demonstrates the swelling ratio of SQAPSF-C10-25 and QAPS-75 at different temperatures in pure water. Upon elevation of the temperature, the swelling ratio of SQAPSF-C10-25 increases only slightly, while the QAPS-75 swells significantly.

FIG. 7a shows a synthetic scheme for obtaining a tertiary amine-functionalized aliphatic side chain precursor containing multiple quaternary ammonium sites (QA(CH₂)₆TA-5).

FIG. 7b shows a scheme for synthesizing a quaternary ammonium cation-strung poly(2,6-dimethyl-1,4-phenylene oxide) (SQAPPO-C6).

FIG. 8 is a schematic drawing illustrating different synthetic routes for preparing a quaternary phosphonium cation-strung polymer.

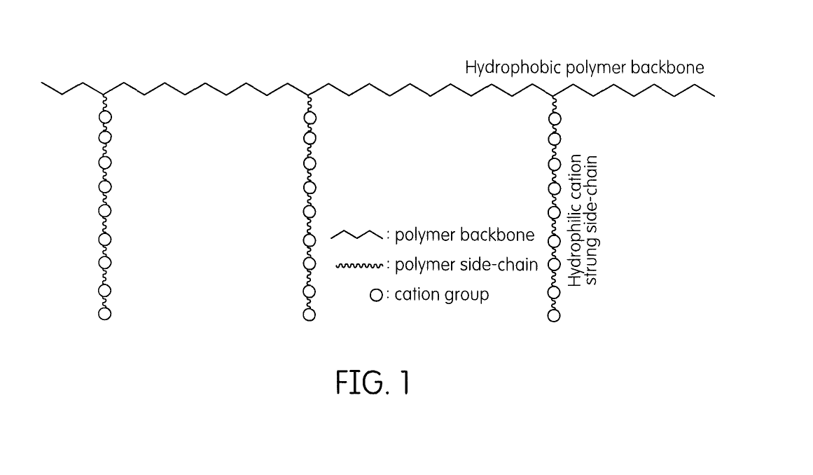

### DETAILED DESCRIPTION OF THE INVENTION

The cation-strung polymers of the present invention may be characterized as being comprised of a polymer backbone of a parent polymer and one or more side chains attached to the polymer backbone, wherein the side chains each contain a plurality of cationic sites. The parent polymers, which provide the backbone to which the cation-containing side chains are attached, generally should be selected so as to be hydrophobic in character. As will be explained in more detail subsequently, the parent polymer should contain one or more functional groups which are capable of linking with side chain precursors to the parent polymer or which are capable of serving as sites for graft oligomerization or polymerization of monomers onto the parent polymer to provide side chains (wherein the cationic sites may be introduced into the side chains following such graft polymerization). Such reactive functional groups may be pendant to the backbone of the parent polymer or in the backbone of the parent polymer itself. In one embodiment, the parent polymer is linear. Although the molecular weight of the parent polymer is thought to be non-critical, generally speaking the parent polymer is sufficiently high in molecular weight to impart the desired or needed mechanical and physical properties to the cation-strung polymer and a hydroxide/anion exchange membrane prepared therefrom.

Illustrative examples of suitable types of parent polymers include, but are not limited to, polysulfones such as poly(aryl ether sulfones), polystyrenes, poly(ether sulfones), poly(ether sulfones)-cardo, poly(ether ketones), poly(ether ketones)-cardo, poly(ether ether ketones), poly(ether ether ketone ketones), poly(phthazinone ether sulfone ketones), polyetherimides, poly(phenylenes), poly(aryl ethers), poly(phenylene oxides) and vinyl aliphatic/aromatic polymers and fluorinated polymers. As mentioned above and as further described in detail below, such parent polymers may initially contain functional groups such as haloalkyl groups, tertiary amine groups and the like that are capable of reacting with functional groups on precursors of the side chains or functional groups such as chloromethyl groups, dithiobenzoate groups or the like that are capable of functioning as initiation sites for the oligomerization or polymerization of monomers to form side chains.

The side chains of the cation-strung polymers of the present invention are pendant to the backbone of the parent polymer. An individual parent polymer molecule may bear a single cation-containing side chain or a plurality of such side chains. The number of cation-containing side chains and their positioning along the parent polymer backbone may be varied and controlled as may be desired to achieve the desired characteristics of the final cation-strung polymer. For example, generally speaking, increasing the number of such side chains per parent polymer chain will tend to increase the overall hydrophilicity of the cation-strung polymer and/or the size or proportion of the hydrophilic domain relative to the hydrophobic domain in the hydroxide/anion exchange membrane prepared from the cation-strung polymer.

The structures of the side chains are selected so that in the cation-strung polymer there is at least one side chain containing a plurality of cationic sites (groups). That is, such side chain may comprise two, three, four or more cationic sites. Where there are three or more cationic sites in a side chain, such sites may be regularly spaced from each other such that the distance between each successive cationic site is the same. However, in another embodiment, the multiple cationic sites may be irregularly or non-uniformly spaced from each other. The types of cationic sites which may be incorporated in the cation-strung polymers of the present invention are not particularly limited and may, for example, be selected from the group consisting of ammonium (including quaternary ammonium), phosphonium (including quaternary phosphonium), guanidinium, imidazolium, sulfonium, pyridinium, and metal-based (e.g., cobalticinium) cationic sites. Combinations of different types of cationic sites may be present within an individual cation-strung polymer.

The cation-strung side chains may be oligomeric or polymeric, containing two or more repeating units. In one embodiment of the invention, the repeating units may have the structure [—CH₂—N⁺(CH₃)₂—CH₂—R—] wherein R is phenyl or biphenyl or —(CH₂)ₙ—, with n=0 to 20. In another embodiment, the repeating units may have the structure [—CH₂—CH(Ar-QP)—] wherein Ar is an aromatic moiety such as a phenyl group and QP is a quaternary phosphonium-containing group substituted on the aromatic moiety. In the latter embodiment, the side chain may additionally contain repeating units which do not contain cationic sites. It is also possible for the cation-strung polymer to additionally comprise one or more side chains which do not contain any cationic sites.

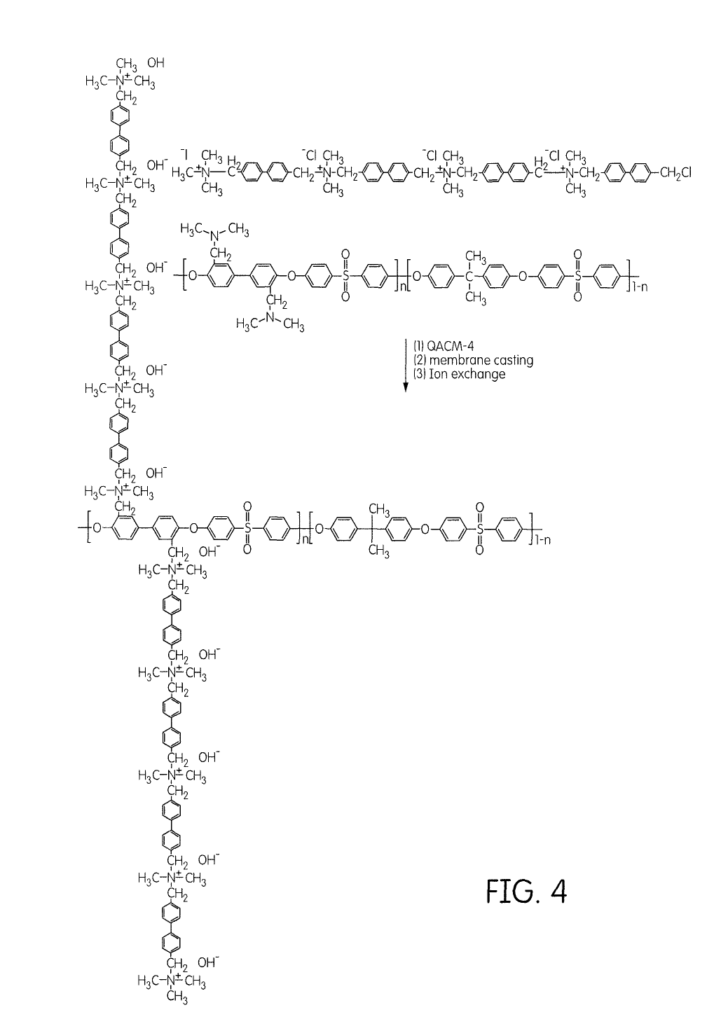

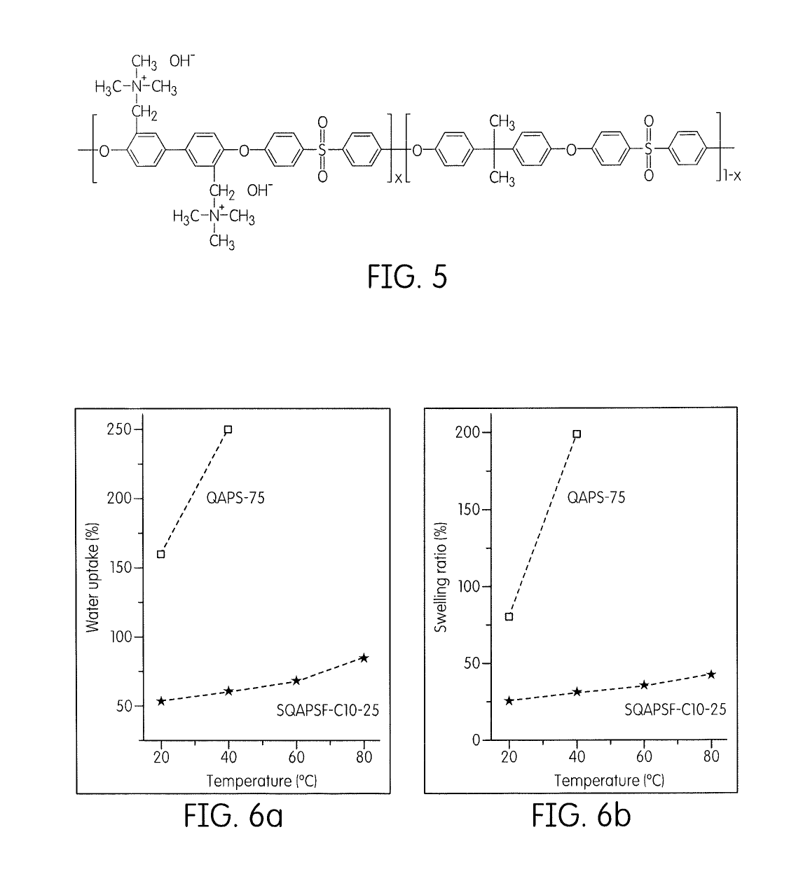

In accordance with one embodiment of the invention, a new quarternary ammonium cation-strung polysulfone (designated SQAPSF-C10, the chemical structure of which is illustrated in FIG. 4) has been synthesized as an example of cation-strung architecture invention and used successfully to prepare hydroxide exchange membranes for fuel cells. The SQAPSF-C10 hydroxide exchange membrane has exhibited high hydroxide conductivity and low water uptake. The following Table 1, which provides a comparison between a cation-strung polymer (SQAPSF-C10) and two polymers that are not cation-strung, makes this apparent.

TABLE 1

| | IEC | Conductivity | Water uptake |
|---|---|---|---|
| Membrane | (mmol/g)^{a} | (mS/cm)^{b} | (%) |
| SQAPSF-C10-20 | 2.34 | 38 | 35 |
| SQAPSF-C10-25 | 2.61 | 54 | 42 |
| SQAPSF-C10-30 | 2.82 | 67 | 53 |
| QAPS-25 | 1.05 | 5 | 10 |
| QAPS-75 | 2.76 | 58 | 160 |

^{a}Calculated from ¹H NMR.
^{b}ID water, 20° C.

The cation-strung polymer of the invention has both high hydroxide conductivity and low water uptake.

According to one aspect of the present invention, a method of producing a cation-strung polymer comprising attaching a cation-strung side chain to a main chain polymer is provided. The method may comprise synthesizing a precursor to the cation-strung side chain, synthesizing a parent polymer providing the desired polymer backbone (main chain), and attaching the cation-strung side chain to the parent polymer. The precursor to the cation-strung side chain and the parent polymer may each contain functional groups reactive with each other. That is, a functional group is present on the parent polymer that is capable of reacting with a functional group on the precursor of the cation-strung side chain so as to form a bond, such as a covalent bond, between the precursor and the parent polymer, thereby attaching the side chain to the parent polymer to form the cation-strung polymer. A single parent polymer molecule may thereby be substituted with one, two, three or more cation-strung side chains.

For example, in one embodiment of the invention, the parent polymer may contain tertiary amine functional groups (e.g., —CH₂N(CH₃)₂) and the side chain precursor may contain a haloalkyl functional group (e.g., —CH₂Cl). A tertiary amine functional group may react with a haloalkyl functional group to form a quaternary ammonium, thereby creating a cationic site and linking the side chain to the parent polymer.

In another embodiment of the invention, haloalkyl functional groups (e.g., —CH₂Br) may be present on the parent polymer and the side chain precursor may contain a tertiary amine functional group (e.g., —N(CH₃)₂). These functional groups are reacted to form a quaternary ammonium, which links the side chain to the parent polymer and also provides a cationic site.

In yet another embodiment of the invention, a non-cationic side chain is grafted onto the backbone of a parent polymer and then subsequently derivatized to provide cationic sites in the side chain. For example, the non-cationic side chain may be introduced through graft oligomerization or polymerization of a vinyl aromatic monomer onto a parent polymer, wherein the vinyl aromatic monomer contains a functional group capable of being derivatized to provide a cationic site (e.g., a chloromethyl group) or wherein the oligomeric or polymeric side chain produced by oligomerization or polymerization of the vinyl aromatic monomer is reacted (e.g., brominated) to provide a functional group (e.g., a bromomethyl group) capable of being derivatized to provide a cationic site.

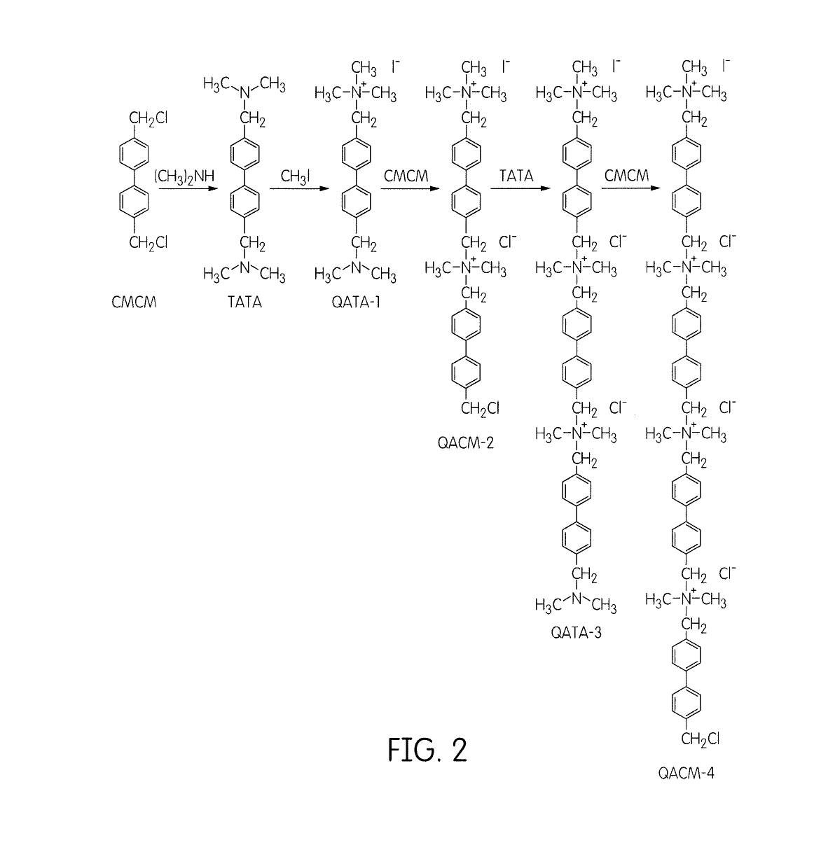

In one embodiment of the method of the present invention (illustrated in FIG. 2), synthesis of an ammonium cation-strung side chain can begin with synthesis of the compound (H₃C)₂N—CH₂—BP—CH₂—N(CH₃)₂, where BP is a biphenyl moiety (TATA). The TATA may be synthesized using dimethylamine aqueous solution and 4,4′-bis(chloromethyl)-1,1′-biphenyl in methanol to form the TATA product. Next, iodomethane can be added dropwise into the TATA solution to obtain (H₃C)₂N—CH₂—BP—CH₂—N⁺(CH₃)₃I⁻ (QATA-1). The QATA-1 can be reacted with ClCH₂—BP—CH₂Cl (CMCM) to form (H₃C)₃N⁺—CH₂—BP—CH₂—N⁺(CH₃)₂—CH₂—BP—CH₂—ClCl⁻I⁻ (QACM-2). Thereafter, the QACM-2 can be reacted with TATA to form (H₃C)₃N⁺−CH₂—[—BP—CH₂—N⁺(CH₃)₂—CH₂—]₂—BP—CH₂—N(CH₃)₂2Cl⁻I⁻ (QATA-3). The QATA-3 can then be reacted with CMCM to form (H₃C)₃N⁺—CH₂—[—BP—CH₂—N⁺(CH₃)₂—CH₂—]₃—BP—CH₂—Cl⁻I⁻ (QACM-4). This synthetic scheme is illustrated in FIG. 2.

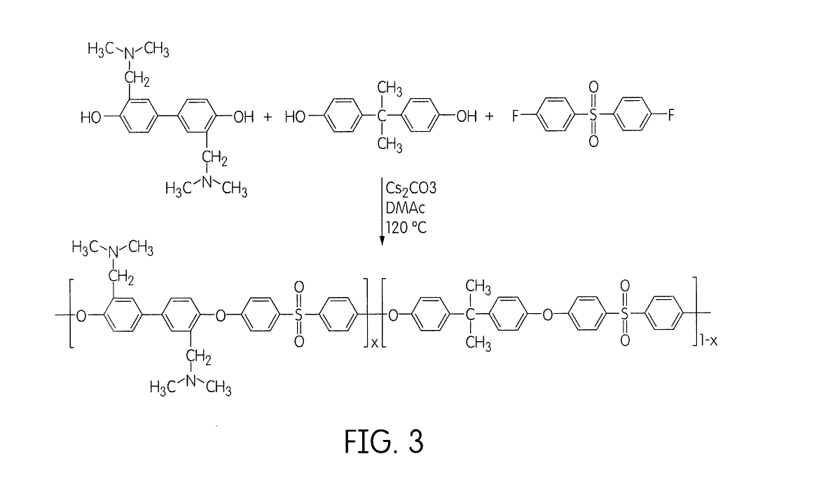

A tertiary amine-functionalized polysulfone (TAPS) suitable for use as the parent polymer can be synthesized using 2,2′-bimethylaminemethylene-4,4′-biphenol and 4,4′-difluorodiphenylsulfone in a 30:70 ratio. The polymerization reaction of these monomers can be carried out to form the TAPS, as illustrated in FIG. 3.

Finally, the quaternary ammonium cation-strung polysulfone chloride polymer can be synthesized by reacting the TAPS with QACM-4, for example, in DMSO solution for 12 hours at 80° C. This reaction is illustrated in FIG. 4. Corresponding membranes can then be created by casting a film of a solution of the cation-strung polymer and curing the polymer solution to remove solvent, for example, in a petri dish at 60° C. for 6-8 hours. The membranes can then be obtained in hydroxide form by ion exchange with an alkali hydroxide, for example by contacting the membrane with 1M KOH at room temperature for 48 hours followed by washing to remove residual KOH.

The cation-strung structure of the polymers of the present invention has a significant impact on reducing water uptake while maintaining hydroxide conductivity. The present invention also provides a hydroxide exchange membrane fuel cell including a cation-strung polymer of this invention. In a preferred embodiment of the invention, the cation-strung polymer used to manufacture a hydroxide exchange membrane is SQAPSF-C10.

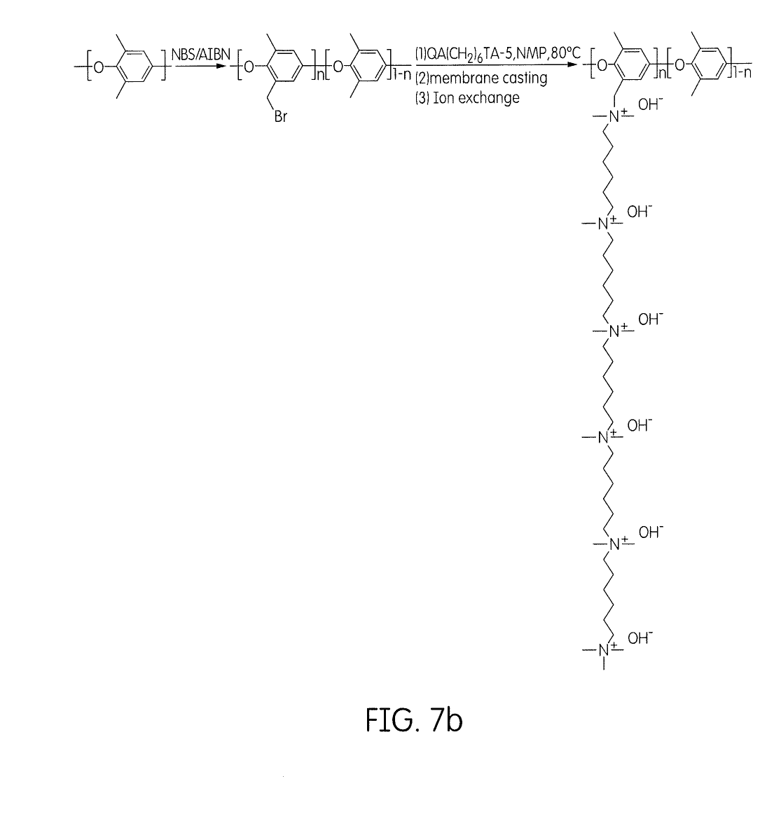

In another method in accordance with the present invention (illustrated in FIG. 7a), synthesis of a cation-strung side-chain which is aliphatic in character can begin with synthesis of the compound (H₃C)₃N⁺(CH₂)₆N(CH₃)₂I⁻ (designated as QA(CH₂)₆TA-1) by adding iodomethane to (H₃C)₂N(CH₂)₆N(CH₃)₂ in THF at room temperature. Next, (H₃C)₃N⁺(CH₂)₆N⁺(CH₃)₂(CH₂)₆I2I⁻ (designated as QA(CH₂)₆I-2) can be obtained by adding QA(CH₂)₆TA-1 to I(CH₂)₆I at room temperature. Then (H₃C)₃N⁺(CH₂)₆—[—N⁺(CH₃)₂(CH₂)₆]₂—N(CH₃)₂3I⁻ (designated as QA(CH₂)₆TA-3) can be created by adding QA(CH₂)₆I-2 to (H₃C)₂N(CH₂)₆N(CH₃)₂ in THF at room temperature. Thereafter, (H₃C)₃N⁺(CH₂)6-[—N⁺(CH₃)₂(CH₂)₆—]₃—I 4I⁻ (designated as QA(CH₂)₆I-4) can be produced by reacting QA(CH₂)₆TA-3 with I(CH₂)₆I, for example, by adding QA(CH₂)₆TA-3 to I(CH₂)₆I at room temperature. Finally, (H₃C)₃N⁺(CH₂)₆—[—N⁺(CH₃)₂(CH₂)₆]₄—N(CH₃)₂5I⁻ (designated as QA(CH₂)₆TA-5) can be produced by reacting QA(CH₂)₆I-4 with (H₃C)₂N(CH₂)₆N(CH₃), for example by adding the QA(CH₂)₆I-4 to (H₃C)₂N(CH₂)₆N(CH₃)₂ in THF at room temperature.

A brominated poly(2,4-dimethyl-1,4-phenylene oxide) (“BrPPO”) useful as a parent polymer can be obtained by bromination of poly(2,4-dimethyl-1,4-phenylene oxide), for example, by adding poly(2,4-dimethyl-1,4-phenylene oxide), N-bromosuccinimide, and 2,2′-azobis-isobutyronitrile into chlorobenzene and reacting by heating at reflux conditions followed by purification with hot ethanol wash. The bromination is illustrated as the first step in the synthetic scheme of FIG. 7b.

The side chain precursor QA(CH₂)₆TA-5 can be attached to the brominated poly(2,4-dimethyl-1,4-phenylene oxide) as illustrated in FIG. 7b. For example, by dissolving the BrPPO in NMP, adding QA(CH₂)₆TA-5 and heating to 80° C., SQAPPO-C6 can be created. Membranes comprising SQAPPO-C6 can then be obtained in hydroxide form by ion exchange using an alkali hydroxide, for example, by contacting the membranes with 1M KOH at room temperature for 48 hours followed by washing to remove residual KOH.

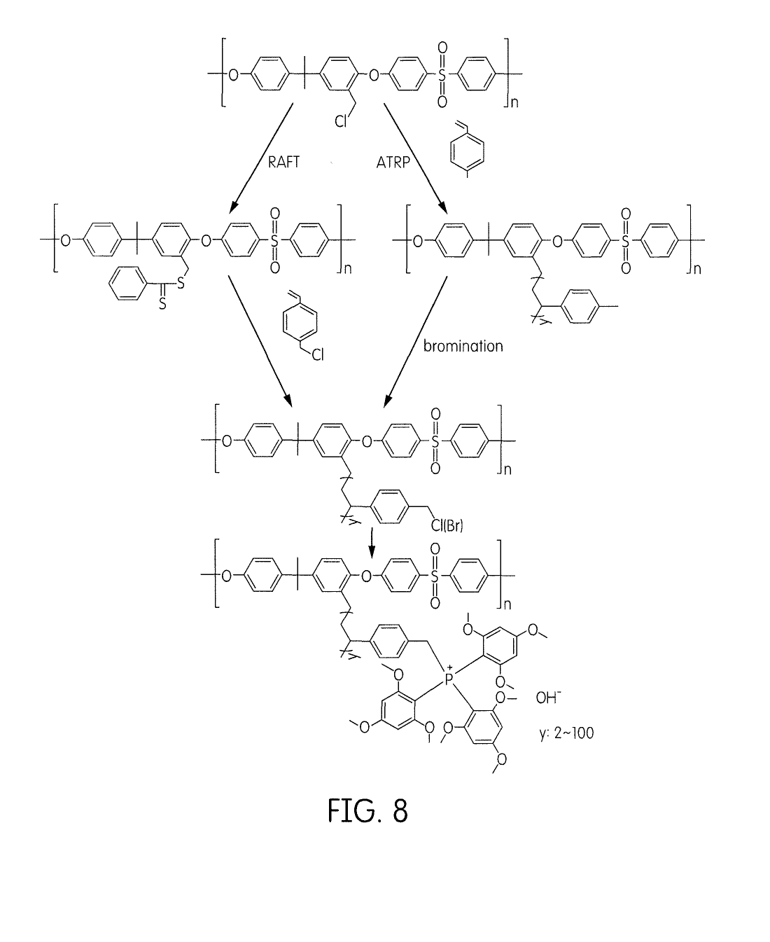

In another method of the present invention, a quaternary phosphonium cation-strung polymer, SQPPSF, may created through reversible addition-fragmentation chain-transfer polymerization (RAFT) or atom transfer random polymerization (ATRP), by adaptation of RAFT and ATRP techniques and procedures known in the polymer art. Specifically, for instance, a polysulfone macro RAFT agent can be obtained by reaction of chloromethylated polysulfone (PSF), sodium dithiobenzoate, and sodium iodide in tetrahydrofuran. Following this, deoxygenated 4-methylstyrene can be added to the mixture to form polysulfone graft polymethylstyrene (PSF-PSt), wherein the 4-methylstyrene is polymerized onto the polysulfone backbone to form side chains. PSF-PSt can then be added to N-bromosuccinimide, and 2,2′-azobis-isobutyronitrile in chlorobenzene and heated to form brominated polysulfone graft methylstyrene (PSF-PStBr). To create the SQPPSF membrane, the PSF-PStBr can be dissolved in NMP and tris(2,4,6-trimethoxyphenyl)phosphine added and heated to finish the reaction by introducing quaternary phosphosphonium groups onto the polymethylstyrene side chains. These synthetic methods are illustrated in FIG. 8. The corresponding SQPPSF membranes can be obtained by curing (drying) the solution and washing the resulting film.

The present invention also provides a hydroxide exchange membrane fuel cell including a cation-strung polymer of this invention. In one particularly advantageous embodiment, the cation-strung polymer is SQPPSF.

This invention provides polymers having side chains strung with cations, as well as methods of making said membrane-forming polymers, having exceptional hydroxide conductivity by virtue of their being strung with cations along their side chains. Membranes formed from the polymers of this invention have applicability in many areas such as HEMFCs, although their use is not limited to such. These anion exchange membranes with different anion ions can be used in a variety of applications, such as electrolysis, solar hydrogen generation, redox flow battery, dialysis, reverse osmosis, forward osmosis, pervaporation, ion exchange, sensor, and gas separation.

The present invention will now be described with reference to the following examples, which serve to illustrate the various embodiments of the present invention and are not intended to be limiting. The skilled person will appreciate that modifications are within the spirit and scope of the invention.

### Example 1

This example illustrates the preparation of a quaternary ammonium-strung polysulfone hydroxide exchange membrane (SQAPSF-C10, FIG. 4). Briefly, SQAPSF-C10 was synthesized by three major steps: (1) synthesis of a cation-strung side-chain precursor, (2) synthesis of a tertiary amine-functionalized polysulfone, and (3) attachment of the cation-strung side chain precursor to the polymer backbone of the tertiary amine-functionalized polysulfone.

### 1.1. Synthesis of the Quaternary Ammonium Cations-Strung Side-Chain Precursor

### Synthesis of the Compound TATA:

60 mL dimethylamine aqueous solution (40 wt. %, i.e., 24 g or 533 mmol) was added into 20 mL solution of 4,4′-bis(chloromethyl)-1,1′-biphenyl (0.5 g/mL, i.e., 40 mmol) in methanol at 0° C. with stirring. After one hour of reaction at 0° C., the temperature was raised to 45° C. for six hours to complete the reaction. The white crystal TATA product was obtained by evaporating the solvent, and then recrystallized from THF. The yield of TATA was 85% (9 g per batch). ¹H NMR (400 MHz, DMSO-d6, δ, ppm): 7.60-7.58 (4H, d, Ar—H), 7.36-7.34 (4H, d, Ar—H), 3.39 (4H, s, —CH₂—), and 2.14 (12H, s, —CH₃).

### Synthesis of the Compound QATA-1:

1.4 g iodomethane (10 mmol) was added dropwise into 40 mL TATA solution in THF (i.e., 2.7 g, or 10 mmol) at room temperature. After stirring for 5 hrs, the white precipitate was collected by filtration and thoroughly washed with THF. The obtained white QATA-1 crystals were purified by recrystallization from THF. The yield of QATA-1 was 85% (3.5 g per batch). ¹H NMR (400 MHz, DMSO-d₆, δ, ppm): 7.84-7.82 (2H, d, Ar—H), 7.70-7.68 (2H, d, Ar—H), 7.63-7.61 (2H, 2d, Ar—H), 7.42-7.40 (2H, d, Ar—H), 4.57 (2H, s, —CH₂—), 3.43 (2H, s, —CH₂—), 3.06 (9H, s, —CH₃), and 2.17 (6H, s, —CH₃).

### Synthesis of the Compound QACM-2:

2.1 g QATA-1 (5 mmol, in 5 mL DMSO) was added dropwise into 20 mL CMCM solution (12.6 g or 50 mmol, in DMSO) at room temperature. After 5 hrs of reaction, white QACM-2 crystals were obtained by evaporating the solvent and thoroughly washing with hot THF. The yield of QACM-2 was 91% (3.0 g per batch). ¹H NMR (400 MHz, DMSO-d₆, δ, ppm): 7.85-7.52 (16H, m, Ar—H), 4.82 (2H, s, —CH₂Cl), 4.76-4.57 (6H, m, —CH₂—), and 3.10-2.82 (15H, m, —CH₃).

Synthesis of the compound QATA-3:

3.3 g QACM-2 (5 mmol, in 5 ml DMSO) was added dropwise into 20 mL TATA solution (13.4 g or 50 mmol, in DMSO) at room temperature. After 5 hrs of reaction, white QATA-3 crystals were obtained by evaporating the solvent and thoroughly washing with hot THF. The yield of QATA-3 was 93% (4.3 g per batch). ¹H NMR (400 MHz, DMSO-d₆, δ, ppm): 7.85-7.52 (22H, m, Ar—H), 7.43-7.41 (2H, d, Ar—H), 4.82 (2H, s, —CH₂Cl), 4.77-4.54 (10H, m, —CH₂—), 3.44 (2H, s, —CH₂—), 3.11-2.82 (21H, m, —CH₃), 2.18 (6H, s, —CH₃).

### Synthesis of QACM-4:

4.6 g QATA-3 (5 mmol, in 5 mL DMSO) was added dropwise into 20 mL CMCM solution (12.6 g or 50 mmol, in DMSO) at room temperature. After 5 hrs of reaction, white QACM-4 crystals were obtained by evaporating the solvent and thoroughly washing with hot THF. The yield of QACM-4 was 88% (5.2 g per batch). ¹H NMR (400 MHz, DMSO-d₆, δ, ppm): 7.85-7.50 (32H, m, Ar—H), 4.81 (2H, s, —CH₂Cl), 4.79-4.58 (14H, m, —CH₂—), 3.12-2.83 (27H, m, —CH₃).

### 1.2. Synthesis of a Tertiary Amine-Functionalized Polysulfone (TAPS)

The DF values of the copolymers, where DF represents the degree of functionalization (the number of tertiary amine groups/repeat unit), were controlled by adjusting the molar ratio of bimethylaminemethylene-4,4′-biphenol to bisphenol A. A typical synthesis procedure of TAPS-30, was as follows: to a flame-dried 100 mL three-necked flask equipped with nitrogen inlet, Dean-Stark trap and overhead stirrer, 0.9012 g 2,2′-bimethylaminemethylene-4,4′-biphenol (3 mmol), 1.5980 g bisphenol A (7 mmol) and 2.5425 g 4,4′-difluorodiphenylsulfone (10 mmol) were dissolved into 50 mL dry DMAc at room temperature (the molar ratio of 2,2′-bimethylaminemethylene-4,4′-biphenol to bisphenol A was 30:70). 7.1 g anhydrous cesium carbonate (22 mmol) and 10 mL cyclohexane were added into the DMAc solution. The temperature was raised to and held at 110° C. for cyclohexane-distilling to completely remove water from the system. When all of the water had been distilled off, the temperature was raised to and held at 120° C. for 8 hrs to complete the polymerization reaction. After cooling down to room temperature, an additional 30 mL of DMAc was added to dilute the highly viscous reacted solution, followed by the filtration to obtain the clear polymer solution. The polymer product in fiber-like precipitate form was obtained by dropping the polymer solution into deionized water, and the polymer product was purified by washing with hot water for several times and then was dried completely. The yield of the polymer TAPS-30 was 98%. ¹H NMR (300 MHz, CDCl₃-d, δ, ppm): 7.89-6.95 (m, Ar—H), 3.41 (s, —CH₂—), 2.25 (s, —CH₃), and 1.71 (s, —CH₃).

### 1.3. Synthesis of a Quaternary Ammonium Cation-Strung Polysulfone Chloride and Preparation of SQAPSF-C10 Membranes.

A typical synthesis procedure of SQAPSF-C10, was as follows: 0.5 g TAPS-30 (0.65 mmol) was first dissolved in 20 mL DMSO, and then 0.8 g QACM-4 (0.68 mmol) was added into the DMSO solution. The quaternary ammonium cation-strung polysulfone chloride polymer was synthesized by reacting the solution at 80° C. for 12 h. The corresponding membranes were obtained by curing the reacted polymer solution in a clear glass plate at 80° C. for 8 hrs. The membranes (in chloride form) were peeled off from the glass plate in contact with deionized (DI) water. The membranes in hydroxide form were obtained by ion exchange in 1 M KOH at room temperature for 48 hrs, followed by washing and immersion in DI water for 48 hrs to remove residual KOH.

### 1.4. Water Uptake and Hydroxide Conductivity

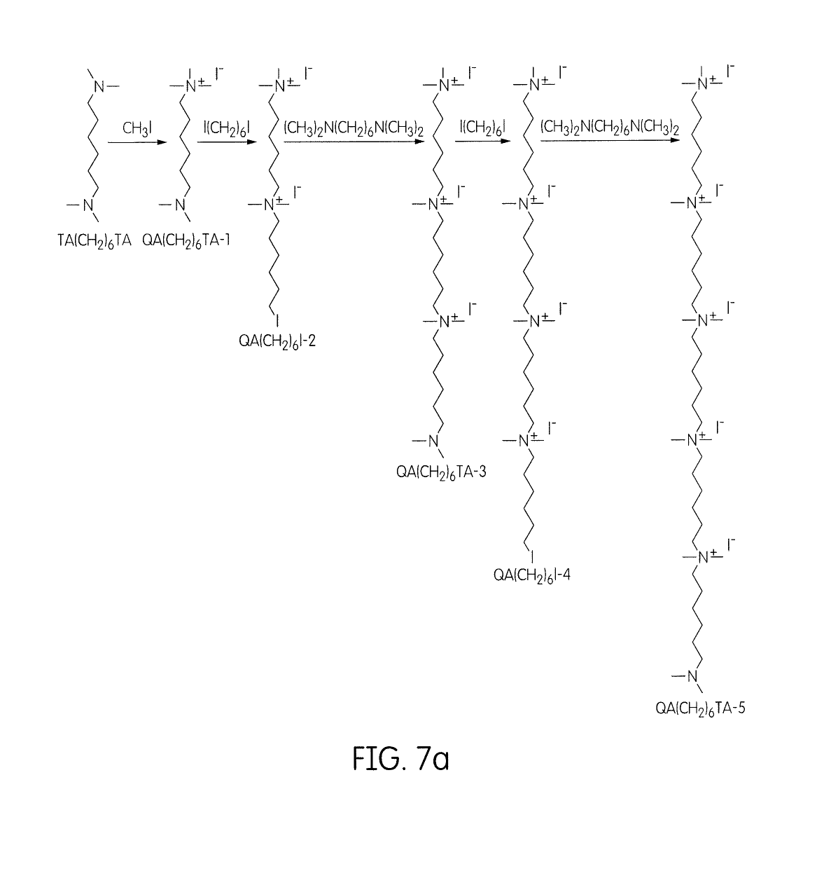

The cation-strung structure has a significant impact on reducing water uptake and maintaining hydroxide conductivity. By contrast, the SQAPSF-C10-30 HEM with cation-strung structure has a 2-fold reduction in water uptake (53% vs. 160% at 20° C.) as compared to poly(aryl ether sulfone) HEM (FIG. 6a) without the cation-strung structure (with the similar IEC). Meanwhile, the SQAPSF-C10-30 HEM maintains the highest level of hydroxide conductivity (67 vs. 58 mS/cm at 20° C.) as compared with QAPS-75 HEM without the cation-strung structure (FIG. 6b).

### Example 2

Example 2 demonstrates the preparation of a quaternary ammonium-strung poly(2,6-dimethyl-1,4-phenylene oxide) hydroxide exchange membrane (SQAPPO-C6, FIG. 7b) in accordance with the invention. SQAPPO-C6 was synthesized by three major steps: (1) synthesis of a cation-strung side-chain aliphatic precursor (see FIG. 7a), (2) synthesis of a brominated PPO, and (3) attachment of the cation-strung side chain aliphatic precursor to the brominated PPO backbone.

### 2.1. Synthesis of the Quaternary Ammonium Cation-Strung Aliphatic Side Chain Precursor

### Synthesis of the Compound QA(CH₂)₆TA-1:

1.4 g iodomethane (10 mmol) was added dropwise into 40 mL TA(CH₂)₆TA solution in THF (i.e., 1.7 g, or 10 mmol) at room temperature. After stirring for 5 hrs, the white precipitate was collected by filtration and thoroughly washed with THF. The obtained white QA(CH₂)₆TA-1 crystals were purified by recrystallization from THF. The yield of QA(CH₂)₆TA-1 was 70% (2.1 g per batch). ¹H NMR (400 MHz, DMSO-d₆, δ, ppm): 3.28-3.24 (2H, m, —CH₂—N⁺—), 3.03 (9H, s, —N⁺—CH₃), 2.18-2.16 (2H, t, —CH₂—N—), 2.10 (6H, s, —N—CH₃), 1.70-1.64 (2H, m, —CH₂—), 1.43-1.38 (2H, m, —CH₂—), and 1.37-1.22 (4H, m, —CH₂—).

### Synthesis of the Compound QA(CH₂)₆I-2:

1.6 g QA(CH₂)₆TA-1 (5 mmol, in 10 mL DMSO) was added dropwise into 40 mL I(CH₂)₆I solution (16.9 g or 50 mmol, in DMSO) at room temperature. After 5 hrs of reaction, white QA(CH₂)₆I-2 crystals were obtained by evaporating the solvent and thoroughly washing with hot THF. The yield of QA(CH₂)₆I-2 was 85% (2.7 g per batch). ¹H NMR (400 MHz, DMSO-d₆, δ, ppm): 3.31-3.32 (8H, m, —CH₂—N⁺—, —CH₂—I), 3.06-3.01 (15H, m, —N⁺—CH₃), 1.79-1.73 (2H, m, —CH₂—), 1.72-1.61 (6H, m, —CH₂—), and 1.45-1.25 (8H, m, —CH₂—).

### Synthesis of the Compound QA(CH₂)₆TA-3:

3.3 g QA(CH₂)₆I-2 (5 mmol, in 20 ml DMSO) was added dropwise into 40 mL TA(CH₂)₆TA solution (8.6 g or 50 mmol, in DMSO) at room temperature. After 5 hrs of reaction, white QA(CH₂)₆TA-3 crystals were obtained by evaporating the solvent and thoroughly washing with hot THF. The yield of QA(CH₂)₆TA-3 was 88% (3.6 g per batch). ¹H NMR (400 MHz, DMSO-d₆, δ, ppm): 3.33-3.24 (10H, m, —CH₂—N⁺—), 3.07-3.01 (21H, m, —N⁺—CH₃), 2.21-2.17 (2H, t, —CH₂—N—), 2.12 (6H, s, —N—CH₃), 1.76-1.59 (10H, s, —CH₂—), 1.44-1.37 (2H, m, —CH₂—), and 1.37-1.23 (12H, m, —CH₂—).

### Synthesis of the Compound QA(CH₂)₆I-4:

4.1 g QA(CH₂)₆TA-3 (5 mmol, in 20 mL DMSO) was added dropwise into 40 mL I(CH₂)₆I solution (16.9 g or 50 mmol, in DMSO) at room temperature. After 5 hrs of reaction, white QA(CH₂)₆I-4 crystals were obtained by evaporating the solvent and thoroughly washing with hot THF. The yield of QA(CH₂)₆I-4 was 90% (5.2 g per batch). ¹H NMR (400 MHz, DMSO-d₆, δ, ppm): 3.32-3.25 (16H, m, —CH₂—N⁺—, 3.07-3.01 (27H, m, —N⁺—CH₃), 1.82-1.76 (2H, m, —CH₂—), 1.75-1.62 (16H, m, —CH₂—), and 1.45-1.25 (14H, m,

### Synthesis of the Compound QA(CH₂)₆TA-5:

5.8 g QA(CH₂)₆I-4 (5 mmol, in 20 ml DMSO) was added dropwise into 40 mL TA(CH₂)₆TA solution (8.6 g or 50 mmol, in DMSO) at room temperature. After 5 hrs of reaction, white QA(CH₂)₆TA-5 crystals were obtained by evaporating the solvent and thoroughly washing with hot THF. The yield of QA(CH₂)₆TA-5 was 95% (6.3 g per batch). ¹H NMR (400 MHz, DMSO-d₆, δ, ppm): 3.32-3.21 (18H, m, —CH₂—N⁺—), 3.07-3.01 (33H, m, —N⁺—CH₃), 2.27-2.22 (2H, t, —CH₂—N—), 2.17 (6H, s, —N—CH₃), 1.76-1.60 (18H, s, —CH₂—), 1.44-1.37 (2H, m, —CH₂—), and 1.37-1.23 (20H, m,

### 2.2. Synthesis of Brominated Poly(2,4-Dimethyl-1,4-Phenylene Oxide) (BrPPO)

A typical synthesis procedure of BrPPO-10 (wherein the designation “10” refers to the degree of bromine functionalization being 10%), was as follows: To a 1 L three-necked flask equipped with condenser and overhead stirrer, 12 g PPO (100 mmol), N-bromosuccinimide (NBS) (1.8 g, 20 mmol), and 2,2′-azobis-isobutyronitrile (0.17 g, 2 mmol) were dissolved into 100 mL chlorobenzene. The mixture was heated at reflux conditions (135° C.) for 1 h. The polymer product in fiber-like precipitate form was obtained by dropping the polymer solution into ethanol, and the polymer product was purified by washing with hot ethanol for several times and then was dried completely. The yield of the polymer BrPPO-10 was 95%. NMR (400 MHz, CDCl₃-d, δ, ppm): 6.70-6.47 (m, Ar—H), 3.34 (s, —CH₂Cl), and 2.08 (s, —CH₃). Other BrPPO polymers with different DF were prepared by using different amounts of NBS according to the above procedure.

### 2.3. Synthesis of the Quaternary Ammonium Cation-Strung PPO and Preparation of SQAPPO-C6 Membranes.

A typical procedure for synthesizing SQAPPO-C6-10 was as follows: 0.50 g BrPPO-10 (0.4 mmol) was first dissolved in 10 mL NMP, and then 0.52 g QA(CH₂)₆TA-5 (0.4 mmol) was added into the solution. The mixture was heated at 80° C. for 8 h to finish the reaction. The corresponding membranes were obtained by curing the reacted polymer solution in a clear glass plate at 80° C. for 8 hrs. The membranes were peeled off from the glass plate in contact with deionized (DI) water. The membranes in hydroxide form were obtained by ion exchange in 1 M KOH at room temperature for 48 hrs, followed by washing and immersion in DI water for 48 hrs to remove residual KOH.

### Example 3

### 3.1. RAFT Method

### 3.1.1. Synthesis of Polysulfone Macro RAFT Agent.

A typical procedure for synthesizing polysulfone (PSF) macro RAFT agent was as follows: To a 500 mL three-necked flask equipped with condenser and overhead stirrer, 10 g chloromethylated PSF, sodium dithiobenzoate (10% excess to chloromethyl groups), and sodium iodide (10% excess to sodium dithiobenzoate) were dissolved into 200 mL dry tetrahydrofuran. The mixture was heated at reflux conditions (60° C.) for 1 h. The polymer product in fiber-like precipitate form was obtained by dropping the polymer solution into ethanol, and the polymer product was purified by washing with hot ethanol and water several times and then was dried completely.

### 3.1.2. Synthesis of Polysulfone Graft Chloromethylstyrene (PSF-PStCl).

A typical procedure for synthesizing polysulfone graft chloromethylstyrene (PSF-PStCl), was as follows: To a flame-dried 100 mL three-necked flask equipped with nitrogen inlet, condenser and overhead stirrer, 1.0 g polysulfone macro RAFT agent, 2.0 g 4-chloromethylstyrene, and 2,2′-azobis-isobutyronitrile (10% of macro RAFT agent) were dissolved into 50 mL dry NMP, and flushed with nitrogen for 1 h. The mixture was heated at 100° C. for 24 h. The polymer product in fiber-like precipitate form was obtained by dropping the polymer solution into ethanol, and the polymer product was purified by washing with hot ethanol and water several times and then was dried completely.

### 3.2. ATRP Method

### 3.2.1. Synthesis of Polysulfone Graft Methyl Styrene (PSF-PSt).

A typical procedure for synthesizing polysulfone graft methylstyrene (PSF-PSt) was as follows: To a flame-dried 100 mL three-necked flask equipped with nitrogen inlet, condenser and overhead stirrer, 1.0 g chloromethylated PSF, 0.05 g CuCl, and 0.16 g 2,2′-bipyridine were dissolved into 50 mL dry NMP, and was degassed and purged with nitrogen three times. Then, 2.0 g of deoxygenated 4-methylstyrene was added and the mixture was heated at 120° C. for 24 h. The polymer product in fiber-like precipitate form was obtained by dropping the polymer solution into ethanol, and the polymer product was purified by washing with hot ethanol and water several times and then was dried completely.

### 3.2.2. Synthesis of Brominated Polysulfone Graft Polymethylstyrene (PSF-PStBr)

A typical procedure for synthesizing PSF-PStBr, was as follows: To a 250 mL three-necked flask equipped with condenser and overhead stirrer, 1 g PSF-PSt, N-bromosuccinimide (10% excess to methyl groups), and 2,2′-azobis-isobutyronitrile (5% of N-bromosuccinimide) were dissolved into 50 mL chlorobenzene. The mixture was heated at reflux conditions (135° C.) for 1 h. The polymer product in fiber-like precipitate form was obtained by dropping the polymer solution into ethanol, and the polymer product was purified by washing with hot ethanol several times and then was dried completely.

### 3.3. Synthesis of a Quaternary Phosphonium Cation-Strung Polysulfone and Preparation of SQPPSF Membranes.

A typical procedure for synthesizing SQPPSF was as follows: 0.50 g PSF-PStCl(Br) was first dissolved in 10 mL NMP, and then tris(2,4,6-trimethoxyphenyl)phosphine (5% excess to chloromethyl/bromomethyl groups) was added into the solution. The mixture was heated at 80° C. for 24 h to finish the reaction. The corresponding membranes were obtained by curing the reacted polymer solution in a clear glass plate at 30° C. for 48 hrs. The membranes were peeled off from the glass plate in contact with deionized (DI) water. The membranes in hydroxide form were obtained by ion exchange in 1 M KOH at room temperature for 48 hrs, followed by washing and immersion in DI water for 48 hrs to remove residual KOH.

A third example of the cation-strung polymers of the present invention is based on polymers containing quaternary phosphonium cations in their side chains (SQPPSF membranes). SQPPSF may be synthesized by a more general method: first grafting side chains onto a chloromethylated polysulfone (CMPSF) through RAFT or ATRP, and then quaternary phosphorization of the side chains (FIG. 8).

All documents, books, manuals, papers, patents, published patent applications, guides, abstracts, and/or other references cited herein are incorporated by reference in their entirety for all purposes. Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A cation-strung polymer comprised of a polymer backbone of a parent polymer and one or more side chains attached to the polymer backbone, wherein the side chains each contain a plurality of cationic sites.

2. The cation-strung polymer of claim 1 wherein the cationic sites are selected from the group consisting of ammonium, phosphonium, guanidinium, imidazolium, sulfonium, pyridinium, and metal-based cationic sites.

3. The cation-strung polymer of claim 1, wherein the parent polymer is a random, block or graft polymer selected from the group consisting of polysulfones, polystyrenes, poly(ether sulfones), poly(ether sulfones)-cardo, poly(ether ketones), poly(ether ketones)-cardo, poly(ether ether ketones), poly(ether ether ketone ketones), poly(phthazinone ether sulfone ketones), polyetherimides, poly(phenylenes), poly(aryl ethers), poly(phenylene oxides), vinyl aliphatic/aromatic polymers and fluorinated polymers.

4. The cation-strung polymer of claim 1, wherein the side chains are aliphatic or aromatic or a combination thereof.

5. The cation-strung polymer of claim 1, wherein the side chains comprise repeating units having the structure [CH₂—N⁺(CH₃)₂—CH₂—R—] and wherein R is phenyl, biphenyl or —(CH₂)ₙ—, with n=0 to 20.

6. The cation-strung polymer of claim 1, wherein the side chains comprise quaternary phosphonium-substituted polystyrene chains.

7. A method of making a cation-strung polymer comprising attaching a cation-strung side chain precursor to a backbone of a parent polymer.

8. The method of claim 7 wherein said cation-strung side chain precursor is an aliphatic cation-strung side chain precursor.

9. The method of claim 7 wherein said parent polymer is selected from the group consisting of polysulfones, polystyrenes, poly(ether sulfones), poly(ether sulfones)-cardo, poly(ether ketones), poly(ether ketones)-cardo, poly(ether ether ketones), poly(ether ether ketone ketones), poly(phthazinone ether sulfone ketones), polyetherimides, poly(phenylenes), poly(aryl ethers), poly(phenylene oxides), vinyl aliphatic/aromatic polymers and fluorinated polymers.

10. The method of claim 7 wherein said parent polymer is selected from the group consisting of tertiary amine-substituted polysulfones, chloromethylated polysulfones and brominated polyphenylene oxides.

11. The method of claim 7 wherein said cation-strung side chain precursor is comprised of repeating units having the structure [CH₂—N⁺(CH₃)₂—CH₂—R—], wherein R is phenyl, biphenyl or —(CH₂)ₙ—, with n=0 to 20.

12. The method of claim 7 wherein said cation-strung side chain precursor has the structure (H₃C)₂N—[—(CH₂)ₘN⁺(CH₃)₂—]ₙ—(CH₂)ₘ—N⁺(CH₃)₃(n+1)X⁻, wherein m is 1 to 20, n is 0 to 97, and X is a halogen.

13. The method of claim 7 wherein said cation-strung side chain precursor has the structure ClH₂C—BP—CH₂—[—N⁺(CH₃)₂—CH₂—BP—CH₂]ₒ—N⁺(CH₃)₃(o+1)X⁻, wherein o is 0 to 97 and X is a halogen.

14. A method of making a cation-strung polymer comprising grafting a chloromethylated vinyl aromatic monomer onto a parent polymer using reversible addition-fragmentation chain-transfer polymerization (RAFT) to obtain a graft copolymer bearing side chains of poly(chloromethylated vinyl aromatic monomer) and reacting the graft copolymer with a tertiary phosphine to introduce quaternary phosphonium groups into the side chains.

15. The method of claim 14, wherein the parent polymer is a polysulfone containing at least one dithiobenzoate group substituted on an aromatic ring.

16. A method of making a cation-strung polymer comprising grafting a methylated vinyl aromatic monomer onto a parent polymer using atom transfer random polymerization (ATRP) to obtain a first graft copolymer bearing side chains of poly(methylated vinyl aromatic monomer), brominating the first graft copolymer to obtain a second graft copolymer bearing side chains containing bromomethyl groups, and reacting the second graft copolymer with a tertiary phosphine to introduce quaternary phosphonium groups into the side chains.

17. The method of claim 16, wherein the parent polymer is a polysulfone containing at least one chloromethyl group substituted on an aromatic ring.

18. A hydroxide exchange membrane comprised of a cation-strung polymer in accordance with claim 1.

19. A hydroxide exchange membrane fuel cell comprising a membrane of a cation-strung polymer in accordance with claim 1.

20. An anion exchange membrane comprised of a cation-strung polymer in accordance with claim 1.

21. A device comprising a membrane of a cation-strung polymer in accordance with claim 1, wherein the device is selected from the group consisting of anion exchange membrane fuel cells, electrolysis devices, solar hydrogen generation devices, redox flow batteries, dialysis devices, reverse osmosis devices, forward osmosis devices, pervaporation devices, ion exchange devices, sensors, and gas separation devices.
